(19) United States
(12) Patent Application Publication
(10) Pub. No.: US 2003/0168160 A1
(43) Pub. Date: Sep. 11, 2003

(54) Adhesive curing apparatus and method

(76) Inventor: Russell Vernon Hughes, Earlsdon (GB)

Correspondence Address: CARLSON, GASKEY & OLDS, P.C., 400 WEST MAPLE ROAD, SUITE 350, BIRMINGHAM, MI, 48009, US

(21) Appl. No.: 10/258,910

(22) PCT Filed: May 2, 2001
(86) PCT No.: PCT/GB01/01926

(30) Foreign Application Priority Data
May 3, 2000 (GB) 0010684.9

(51) Int. Cl. B32B 31/00

(52) U.S. Cl. 156/272.2; 156/497

(57) ABSTRACT

A method of curing a thermosetting adhesive (18) provided at the interface of two overlapping members (12, 14), the method comprising the steps of: providing two overlapping members (12, 14) having at their interface a thermosetting adhesive (18); providing plasma discharge heating means (24) operable to produce a plasma jet (42); and operating said plasma discharge heating means (24) to produce a plasma jet (42) to heat the or each overlapping member (12, 14) and thereby cure said thermosetting adhesive (18).

The present invention relates a method and apparatus for the curing of thermosetting adhesive, and in particular, though not exclusively, to the curing of thermosetting adhesive used to bond metal having a tenacious surface oxide layer, for example aluminium alloy.

The high strength and low weight of aluminium alloy has traditionally lead to its use in applications where such factors are critical, for example in the aerospace industry. More recently it has begun to be used in the automotive industry as the material for vehicle body and chassis components.

Difficulties exist in the joining of aluminium alloy components due to the inherent nature of the material. The thermal conductivity of aluminium alloy ranges, depending upon its composition, from three to five times that of steel, and hence for welding operations significantly higher inputs of thermal energy are required to achieve fusion. Such high inputs of thermal energy may cause distortion of the workpieces. For the welding of thick sections, preheating of the workpieces may be required. Further complications arise from the fact that aluminium alloy has a surface film of aluminium oxide which forms rapidly when it is exposed to the atmosphere. Typically this oxide layer requires removal from the workpieces before welding. Oxide removal operations are time consuming and require a high degree of workpiece cleanliness to be maintained if subsequent welding operations are to be successful.

As an alternative to welding, riveting operations have been used to join aluminium alloy components. Aluminium riveting operations are typically more expensive and time consuming than welding operations, however they do not require the surface oxide layer to be removed. Riveting is limited to use for the joining of internal vehicle chassis and body components as the presence of rivet heads on exterior body panels is aesthetically undesirable. The bulky nature of the equipment needed to achieve a riveted joint means that gaining access to an intended riveting site may cause problems.

To this end, adhesive is used to bond components which are deemed unsuitable for welding or riveting. Typically a thermosetting adhesive is utilised at the interface between two or more aluminium alloy components. To achieve curing the adhesive needs to be heated to a curing temperature which may typically be in the region of 180° C. to 220° C. To achieve an adhesive bond having optimum strength it is important that the adhesive is cured at the required temperature for a predetermined time period. Underheating of the adhesive may lead to only partial curing and a resultant bond which. is below the desired strength, while overheating may lead to thermal decomposition of the adhesive.

It is known to utilise induction heating in order to cure adhesive interspersed between metallic components, however it has been found that it is difficult to accurately monitor and vary the thermal energy input required to ensure adequate curing.

According to a first aspect of the present invention there is provided a method of curing a thermosetting adhesive provided at the interface of two overlapping members, the method comprising the steps of:

providing two overlapping members having at their interface a thermosetting adhesive;

providing plasma discharge heating means operable to produce a plasma jet; and

operating said plasma discharge heating means to produce a plasma jet to heat the or each overlapping member and thereby cure said thermosetting adhesive.

For the avoidance of doubt the phrase plasma discharge heating means is intended to cover means which, in use, produce a stream of heated, ionised gas or plasma. The method thus described utilises the energy of the ionised gas or plasma to provide a thermal energy input to cure the thermosetting adhesive. The overlapping members may be of metal, for example aluminium alloy. The overlapping members may however be manufactured from any material which is compatible with the heat generated by the plasma discharged heating means. The term compatible is intended to convey the meaning that the material does not melt, decompose, ignite, lose structural integrity or dimensional stability or otherwise adversely change as a result of the thermal energy input, yet permits the transmission of sufficient thermal energy to the adhesive to effect curing thereof

In a preferred embodiment the method includes the step of providing a control system operable to control the plasma discharge means, the control system including sensor means operable to sense the temperature of the workpiece during heating and in response thereto control the plasma jet of the plasma discharge means. The sensor means may be of a non-contact type, for example an optical pyrometer. In an alternative embodiment the sensor means may be adapted to contact the workpiece so as to sense the temperature thereof. In such an embodiment the sensor means may include a thermocouple.

The step of operating the plasma discharge means may include pulsing of said discharge means so as to alter the intensity of the plasma jet.

The method may include the step of generating an arc between the plasma discharge heating means and at least one of the overlapping members in addition to the plasma jet.

The method include the step of cooling a portion of the overlapping members during heating thereof. Cooling may be effected by the provision of a cooled support adapted to rest against the overlapping members or alternatively by a gas jet directed at said members.

The method may further include the steps of moving the overlapping members and/or the plasma discharge heating means relative to one another, in use.

According to a second embodiment there is provided an adhesive curing apparatus, the apparatus comprising a plasma discharge heating means operable to provide a plasma jet, in use.

In a preferred embodiment the plasma discharge heating means comprises a plasma arc torch. In such an embodiment, the plasma arc torch may be operable to provide a plasma jet or a combined plasma jet and transferred arc extending between the torch and a workpiece. The plasma arc torch may be of the non transferred arc type, where an arc is generated between the electrode and constricting nozzle, or the transferred arc type, where an arc is generated between the electrode and the workpiece. In an alternative embodiment the plasma discharge heating means may comprise a gas tungsten arc torch.

The plasma arc torch may be a plasma arc welding torch. The apparatus may thus be operated to undertake both welding and curing operations. In such an embodiment curing operations may be effected by utilising and controlling a non transferred arc of the torch and plasma gas flowrate. Welding operations may on the other hand be effected utilising and controlling, for example, a transferred arc and the plasma gas flow rate. Such an apparatus may be used on workpieces requiring welding and curing operations to be carried out on different portions thereof

Preferably the plasma arc torch includes control means operable to vary the operating characteristics thereof More specifically, the control means may be operable to alter, for example, the arc current and gas flow rate to the electrode. In a preferred embodiment, the apparatus includes sensor means adapted to monitor the temperature of a workpiece upon which the curing apparatus is used. The output from the sensor means is utilised by the control system to vary operating characteristics of the plasma arc torch so as to ensure that a desired curing temperature is maintained. The sensor means may be of a non-contact type, for example an optical pyrometer. In an alternative embodiment the sensor means may be adapted to contact the workpiece so as to sense the temperature thereof. In such an embodiment the sensor means may include a thermocouple.

The apparatus may include cooling means operable to cool portion of a workpiece while the plasma discharge heating means are in operation. Where the workpiece is essentially planar, the cooling means may be provided on a side opposite to that subjected to the output from the plasma discharge heating means. in one embodiment the cooling means may comprise a cooled support having a support surface adapted to rest against the workpiece in use. Such a support may be provided with an internal cavity spaced from the support surface and through which a cooling medium may be circulated. In an alternative embodiment the cooling means may comprise a jet of gas such as air.

The apparatus may be mounted so as to be movable relative to the overlapping members. Additionally, or alternatively, the overlapping members may be movable relative to the apparatus. The apparatus may be mounted on a computer controlled multi-axis support means. In such an embodiment the apparatus may be moved, in use, so as to cure the adhesive provided between the overlapping members in a predetermined pattern.

Embodiments of the present invention will now be described with reference to the accompanying drawings in which:

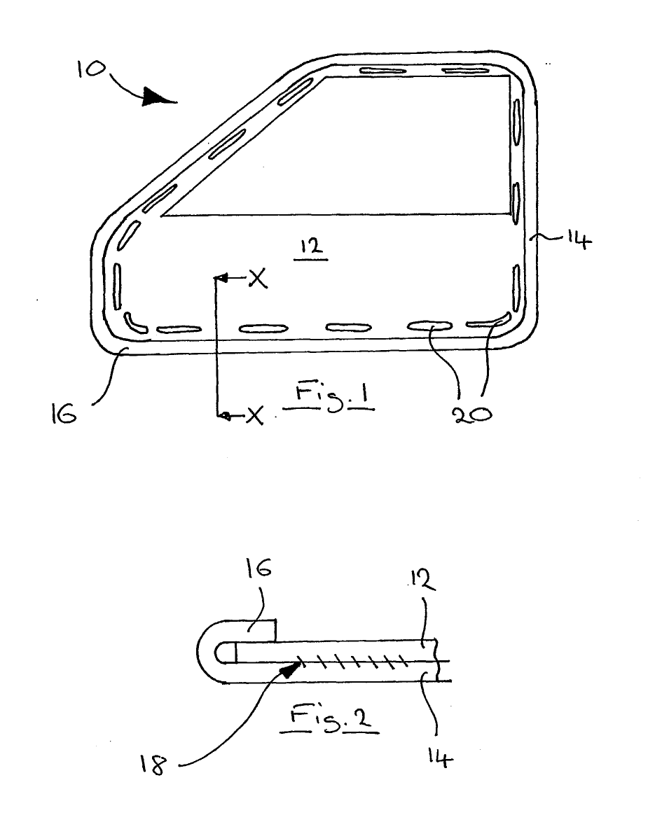

FIG. 1 shows a side view of a vehicle door;

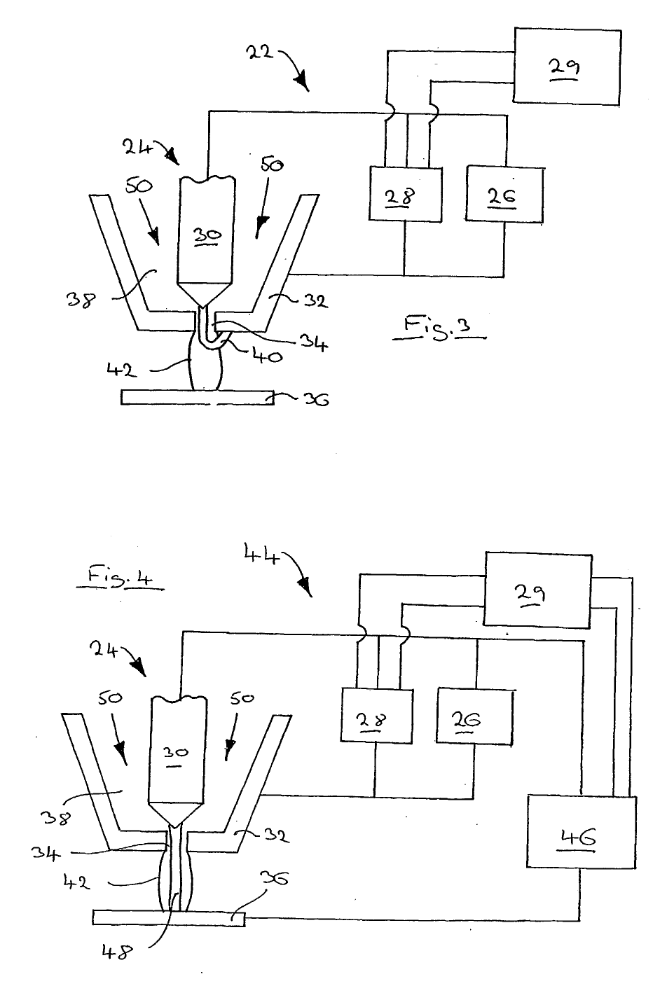

FIG. 2 shows a cross sectional view indicated X-X on FIG. 1;

FIG. 3 shows a schematic view of a plasma arc torch system operable to produce a non-transferred arc;

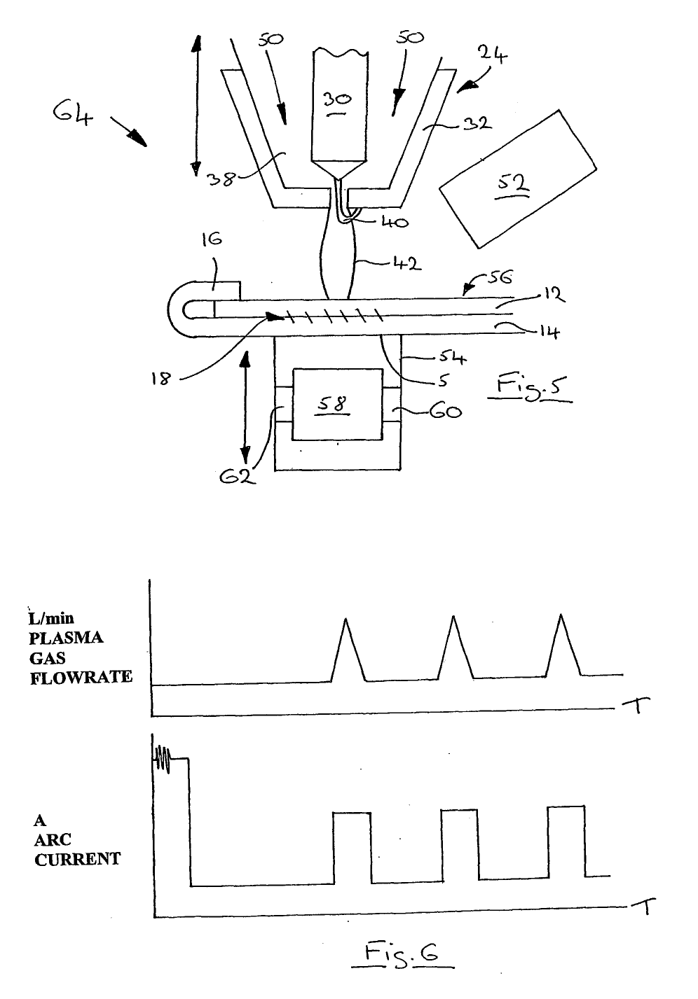

FIG. 4 shows a schematic view of a plasma arc torch system operable to produce a transferred arc;

FIG. 5 shows a cross-sectional side view of curing apparatus according to the present invention;

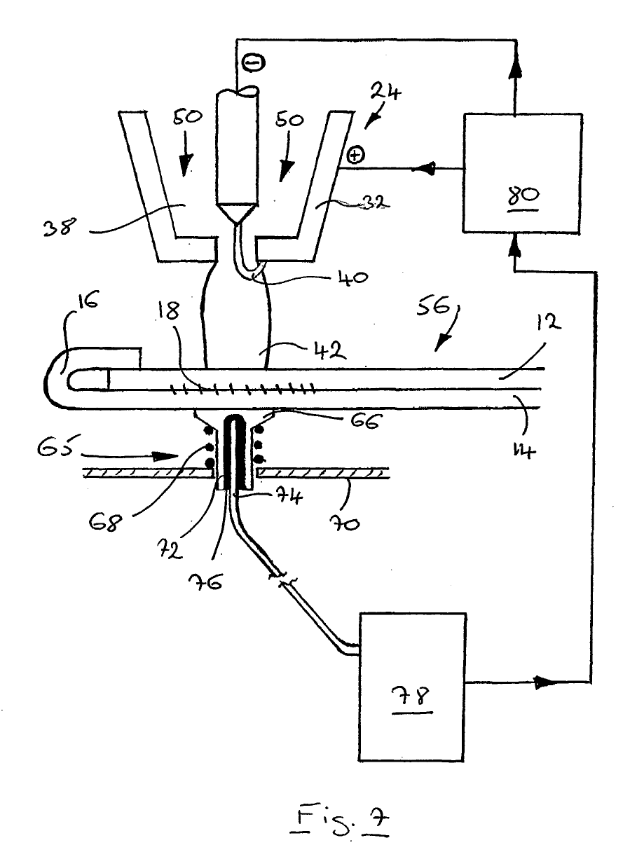

FIG. 6 shows a possible variations in arc current and plasma gas flowrate with respect to time for the apparatus of FIG. 5; and

FIG. 7 shows a cross-sectional side view of an alternative embodiment of a curing apparatus according to the present invention.

Referring firstly to FIGS. 1 and 2 there is shown a vehicle door generally designated 10. The door 10 essentially comprises inner and outer aluminium alloy skins 12, 14 having a thickness of around 1 mm. The outer skin 14 is larger than the inner skin 12 so as to enable the edge 16 of the outer skin 14 to be folded over the inner skin 12 as shown in FIG. 2. The mere folding of the edge 16 does not provide sufficient force to clamp the skins 12, 14 to one another, and consequently a thermosetting adhesive is used to bond the skins 12, 14 to one another. In the embodiment shown, a peripheral layer of adhesive, indicated by hatching 18 on FIG. 2, is provided between the skins 12,14 prior to their being offered together. After folding of the edge 16, the adhesive 18 requires curing by the application of thermal energy thereto so as to provide a bond having the required strength. FIG. 1 shows a possible cured configuration wherein a plurality of discontinuous cured zones 20 are provided around the periphery of the door 10.

Referring now to FIG. 3 there is shown a plasma arc torch system, generally designated 22, comprising a plasma torch 24 which is connected to a high frequency generator 26 and a direct current (DC) power source 28. The power source 28 is in turn connected to a controller 29. The torch 24 essentially comprises a non-consumable electrode 30 surrounded by a constricting nozzle 32 having an orifice 34 facing a workpiece 36. The constricting nozzle 32 defines a chamber 38 around the electrode 30 A further shielding nozzle (not shown) surrounds the constricting nozzle 32.

In use, the system 22 is operated to generate an arc 40 between the electrode 30 and the constricting nozzle 32. The arc 40 heats an inert gas (indicated by arrows 50) fed into the chamber 38 to a temperature where it becomes ionised and able to conduct electricity. In this state the gas is commonly referred to as a plasma. By increasing the flow rate of the gas a plasma jet 42 can be caused to extend from the orifice 34. The temperature of the plasma jet 42 can be varied, for example by altering the arc current and gas flow rate via the controller 29.

The arrangement shown in FIG. 3 produces a non transferred arc, which is to say that the arc 40 is established and maintained between the electrode 30 and the constricting nozzle 32. The workpiece 36 does not form part of the arc circuit and hence heating of the workpiece 36 is obtained from the plasma jet 42 only.

FIG. 4 shows an alternative system which is more typical of actual plasma welding equipment whereby the workpiece 26 forms part of the arc circuit. Here the system 44 includes an additional power supply 46 connected between the electrode 30 and the workpiece 26, which power supply 46 is also controllable by the controller. This system 44 is operable to generate an arc 48 between the electrode 30 and the workpiece 36. This is commonly referred to as a transferred arc 48 as it “transfers” from the electrode 30 to the workpiece 36. Heating of the workpiece 36 is thus obtained from both the plasma jet 42 and the anode spot where the transferred arc 48 impinges upon the workpiece 36.

Typically in a plasma welding apparatus a non transferred pilot arc is generated between the electrode 30 and constricting nozzle 32 which is utilised, by increasing the arc current, to generate a main transferred arc 48 between the electrode 30 and workpiece 26. Once the main arc 48 has been established the pilot arc current is reduced to so as to maintain the pilot arc until it is next needed.

FIG. 5 shows an apparatus 64, including a plasma torch 24 of the non transferred arc type described above in relation to FIG. 3, adapted to supply thermal energy to a workpiece to effect curing of a thermosetting adhesive thereon. The apparatus further comprises a sensor 52 for monitoring the thermal energy input to the workpiece and a support 54. In the embodiment shown the workpiece comprises a double skinned panel 12, 14, 56 having a folded edge 16 and a layer of adhesive 18 interspersed between the skins 12, 14.

The support 54 has a support face 57 adapted to rest against the panel 56, in use. The support 54 includes an internal chamber 58 having both an inlet and an outlet 60, 62 which enable a cooling fluid, for example water, to be circulated through the chamber 58. The cooled support 54 is utilised to prevent marking of the outer skin 14. Both the support 54 and plasma torch 42 are arranged so as to be movable towards and away from their respective sides of the workpiece 56. The sensor 52 may be of any suitable type and for example may be an optical pyrometer. The sensor 52 forms part of a control system, the operation of which is described in more detail below, which monitors and regulates the thermal energy input to the panel 56.

In use, an uncured panel 56 is positioned relative to the apparatus 64 for example in an appropriately configured holding frame or jig. The torch 42 is then moved to an initial position spaced from the panel 56 and the support 54 moved into contact with the opposing side thereof. The spacing of the torch 42 from the panel 56 may be achieved for example by the use of an electromagnetic proximity sensor, an optical sensor, or by first advancing the torch 42 until it contacts the panel 56 and then retracting it a known distance. The torch 42 is then operated, by increasing the arc current and gas flowrate, to direct a plasma jet 42 onto the panel 56.

The sensor 52 monitors the temperature of the panel and hence the control system is able to determine the temperature to which the adhesive 18 in the vicinity of the plasma jet 42 has been heated to. The control system may vary such factors as the arc current, gas flow rate and overall time during which the panel 56 is subjected to the plasma jet in order to ensure that the adhesive is heated to an effective curing temperature.

FIG. 6 shows with reference to arc current and gas flowrate a method of pulsing the arc. Referring firstly to the arc current verses time representation, the arc current is initially set to an elevated level and pulsed so as to strike the arc between the electrode and constricting nozzle. Once the arc has been established the arc current is reduced to an idling level. When it is desired to input thermal energy to a workpiece the arc current is increased to a predetermined level for a predetermined time period before reverting to the idling level. In tandem with the increase and decrease in the arc current the gas flowrate is pulsed so as to increase the size and temperature of the plasma jet. In the time period between pulses, the sensor monitors the temperature of the workpiece and thus can alter the torch operating parameters in advance of the next pulse if deemed necessary. Typically the idling arc current level is between 1 and 30 amps, while the elevated arc current level is in the region of 30 to 300 amps.

Referring now to FIG. 7 there is shown an alternative sensor arrangement for monitoring the temperature of the workpiece. As before the workpiece comprises a double skinned panel 12,14, 56 having a folded edge 16 and a layer of thermosetting adhesive 18 interspersed between the skins 12,14. The plasma torch 24 is of the non-transferred arc type described above in relation to FIG. 3. Instead of the optical pyrometer sensor 52 described in above, the embodiment shown in FIG. 7 is provided with a contact sensor, generally designated 65. The sensor 65 comprises a thermally conductive anvil or contact pad 66 adapted to, in use, contact the panel 56. The contact pad 66 is supported on a spring 68 which in turn is carried by a support member 70. The spring biasing of the contact pad 66 ensures that, in use, adequate contact is maintained with the panel 56.

The contact pad 66 includes a central recess 72 within which there is provided a thermocouple 74. The thermocouple 74 is bonded into the recess 72 with adhesive 76. The thermocouple 74 is connected to a thermocouple monitoring unit 78 which in turn is arranged for communication with a control unit 80 for the plasma torch 24.

In use, the contact pad 66 is positioned against the panel 56 on the opposite side to the plasma torch 24. When heat is applied to the panel 56, heat energy travels through the inner skin 12 to the adhesive 18 and then through to the outer skin 14, the contact pad 66 and ultimately to the thermocouple 74. As the skins 12,14 are relatively thin, rapid heat transfer to the contact pad 66 and thermocouple 74 occurs. The contact pad 66 is manufactured from a heat conductive material such as, for example, copper or silver.

The thermocouple 74 generates a voltage output proportional to its temperature which passes to the monitoring unit 78. The output from the thermocouple 74 is processed by the monitoring unit 78 which in turn generates an output signal to the control unit 80 indicative of the temperature at the curing site. Depending upon the sensed temperature, the control unit 80 may vary operating parameters of the plasma torch 24 to achieve the desired curing temperature. For example, the control unit 80 may alter the intensity of the arc current and/or plasma gas flow rate. It will be understood that the control unit 80 is arranged to ensure that the curing temperature is maintained between set upper an lower levels.

It will be understood that multiple contact pads 66 may be incorporated into a workpiece holding jig, with each contact pad 66 corresponding to a curing site on a given workpiece. It will further be appreciated that thermocouple devices are rugged and reliable items with a proven track record in industrial environments.

The embodiment described above relates to a plasma torch having a non transferred arc. By confining the arc within the plasma torch and relying on the plasma jet to transmit thermal energy to the workpiece, the risk of arc damage to the workpiece is eliminated while the risk of inadvertently melting the workpiece is greatly reduced. Thus it will be appreciated that the use of a non transferred arc is particularly suited to applications where the adhesive is provided at the interface of members having a thin cross-section and/or in applications where a substantially unblemished surface finish to the workpiece is required. Typically the use of a non transferred arc is suited for members having a thickness of around 1 mm.

However, the use of a plasma jet only is less efficient at transmitting thermal energy than a combined plasma jet and transferred arc. Thus it will be apparent to those skilled in the art that this method is suitable where the adhesive is interspersed between members having relatively thick cross-sections and/or where surface marking of the members is not an issue.

It will further be understood that the apparatus of the present invention may be provided on a movable support and hence be able move around the work piece, for example a vehicle door, curing adhesive at a plurality of sites. Such an apparatus may be operable so as to cure an elongate “run” by moving either the apparatus or the workpiece relative to the other. In such an embodiment the fluid cooled support may be replaced by alternative cooling means, for example a jet of gas such as air.

The above described embodiments utilise a plasma torch to input thermal energy to a workpiece. However it will be understood that an appropriately configured gas tungsten arc torch may be substituted in its place. In a gas tungsten arc welding torch the electrode extends beyond the end of a shielding gas nozzle and, when struck, provides a somewhat conical plasma shrouded transferred arc between the electrode and the workpiece.

While the embodiment described above relates to the curing of a thermosetting adhesive provided between skins comprising a metal having a tenacious surface oxide layer, such as aluminium alloy, it will be understood that the method and apparatus is equally suitable for use with other metals, for example mild steel. Indeed the use of the apparatus and method is limited by the material characteristics of the overlapping members and hence may be used in conjunction with materials which are not adversely affected by the thermal input from the apparatus.

1. A method of curing a thermosetting adhesive provided at the interface of two overlapping members, the method comprising the steps of:
providing two overlapping members having at their interface a thermosetting adhesive;
providing plasma discharge heating means operable to produce a plasma jet; and
operating said plasma discharge heating means to produce a plasma jet to heat the or each overlapping member and thereby cure said thermosetting adhesive.

2. A method as claimed in claim 1, the method including the step of providing a control system operable to control the plasma discharge heating means, the control system including sensor means operable to sense the temperature of the workpiece during heating and in response thereto control the plasma jet of the plasma discharge heating means.

3. A method as claimed in claim 2 wherein the sensor means are optical sensor means.

4. A method as claimed in claim 2 wherein the sensor means are adapted to contact one of the overlapping members, in use.

5. A method as claimed in any preceding claim, wherein the step of operating the plasma discharge heating means includes pulsing of said plasma discharge heating means so as to alter the intensity of the plasma jet.

6. A method as claimed in any preceding claim, wherein the method includes the step of generating an arc between the plasma discharge heating means and at least one of the overlapping members in addition to the plasma jet.

7. A method as claimed in any preceding claim, wherein the method includes the step of cooling a portion of the overlapping members during heating thereof.

8. A method as claimed in any preceding claim, the method further includes the step of moving the overlapping members relative to the plasma discharge heating means, in use.

9. A method as claimed in any preceding claim, the method further including the step of moving the plasma discharge heating means relative to the overlapping members, in use.

10. An adhesive curing apparatus, the apparatus comprising a plasma discharge heating means operable to provide a plasma jet, in use, the plasma discharge heating means including control means operable to alter the arc current.

11. An apparatus as claimed in claim 10, wherein the plasma discharge heating means comprises a plasma arc torch.

12. An apparatus as claimed in claim 11, wherein the plasma arc torch is operable to provide a plasma jet extending between the torch and a workpiece.

13. An apparatus as claimed in claim 11 or claim 12, wherein the plasma arc torch is operable to provide a combined plasma jet and transferred arc extending between the torch and a workpiece.

14. An apparatus as claimed in claim 10, wherein the plasma discharge heating means comprises a gas tungsten arc torch.

15. An apparatus as claimed in any of claims 10 to 14, wherein the control means is operable to alter the plasma gas flow rate.

16. An apparatus as claimed in any of claims 10 to 15, the apparatus including sensor means adapted to monitor the temperature of a workpiece upon which the curing apparatus is used.

17. An apparatus as claimed in claim 16 wherein the sensor means are optical sensor means.

18. An apparatus as claimed in claim 16 wherein the sensor means are adapted to contact a workpiece upon which the apparatus is utilised, in use.

19. An apparatus as claimed in claim 18 wherein the sensor means comprise a heat conductive pad adapted to contact a workpiece, said pad incorporating a thermocouple.

20. An apparatus as claimed in claim 19 wherein the heat conductive pad is spring mounted to a support member.

21. An apparatus as claimed in any of claims 10 to 20, the apparatus including cooling means operable to cool a portion of a workpiece.

22. An apparatus as claimed in claim 21, wherein the cooling means comprise a cooled support having a support surface adapted to rest against the workpiece, in use.

23. An apparatus as claimed in claim 22, wherein the support is provided with an internal cavity spaced from the support surface and through which a cooling medium may be circulated.

24. An apparatus as claimed in claim 21, wherein the cooling means comprises a jet of gas directed at the workpiece.

25. An apparatus as claimed in any of claims 10 to 24, the apparatus being mounted so as to be movable relative a workpiece.

26. An apparatus as claimed in any of claims 10 to 25, wherein the workpiece is movable relative to the apparatus.

27. An apparatus as claimed in claim 25 or claim 26, wherein the apparatus is mounted on a computer controlled multi-axis support means.

28. An apparatus as claimed in claim 27, wherein the apparatus is moveable, in use, so as to cure adhesive in a predetermined pattern.
